(19) United States
(12) Patent Application Publication
(10) Pub. No.: US 2020/0378683 A1
(43) Pub. Date: Dec. 3, 2020

(54) BULK MATERIAL DRYING APPARATUSES AND METHODS

(71) Applicant: 670988 NB Inc., Tracadie-Sheila (CA)

(72) Inventors: Neri Jean, Tracadie-Sheila (CA); Philippe Noël, Tracadie-Sheila (CA); Conrad David Cormier, Memramcook (CA)

(21) Appl. No.: 15/929,870

(22) Filed: May 27, 2020

Related U.S. Application Data
(60) Provisional application No. 62/853,112, filed on May 27, 2019.

(51) Int. Cl. F26B 17/04; F26B 17/12; F26B 17/14; F26B 21/10

(52) U.S. Cl. CPC F26B 17/04; F26B 17/12; F26B 2200/02; F26B 21/10; F26B 17/1466

(57) ABSTRACT

An apparatus for drying bulk material can include a housing defining a chamber, an inlet for receiving the bulk material into the chamber, and an outlet for discharging the bulk material from the chamber. At least one conveyor mechanism can be disposed within the housing and can be arranged to convey the bulk material from the inlet to the outlet. A ventilation system can be coupled to the chamber and configured to remove water vapor from the chamber. A method of drying bulk material can include receiving the bulk material into a chamber, conveying the bulk material within the chamber, removing water vapor from the chamber, and discharging the bulk material from the chamber. The system can be used to process peat moss or other bulk materials, such as soil, manure, wood pulp, vegetables, or other products.

### CROSS-REFERENCE TO RELATED APPLICATION

This application claims priority to U.S. Provisional Application No. 62/853,112 filed on May 27, 2019, the entire contents of which are hereby incorporated herein by reference.

### FIELD

The present disclosure relates generally to apparatuses for and methods of drying bulk materials.

### BACKGROUND

The following paragraphs are not an admission that anything discussed in them is prior art or part of the knowledge of persons skilled in the art.

U.S. Pat. No. 8,353,118 discloses a peat moss harvesting apparatus including a conveyor mechanism and a cutting mechanism. The cutting mechanism is guided through a peat moss bed to cut a section of peat moss. The section of peat moss is progressively loaded onto the conveyor mechanism as the section of peat moss is being cut.

United States Publication No. 2013/0333253 discloses a peat moss harvesting apparatus including a supporting structure attachable to a carrier vehicle, and a conveyor mechanism mounted to the supporting structure. The conveyor mechanism includes first and second pulleys and a belt assembly. The belt assembly includes at least one flexible drive element, a plurality of transverse supports mounted to the drive element, and a plurality of cover members mounted to the transverse supports. The cover members define a support surface for conveying material. The transverse supports may be longitudinally spaced apart from one another along the drive element. Each of the cover members may be fixed to a respective one of the transverse supports.

United States Publication No. 2019/0153861 discloses an apparatus including a top portion and a middle portion. The top portion includes an inlet for receiving peat moss. A feeding mechanism delivers the peat moss from the top portion to the middle portion. A compression mechanism housed in the middle portion includes at least one roller assembly for at least partially dewatering the peat moss. The roller assembly can include upper and lower rollers. Peat moss passing between the rollers can be pressed to reduce moisture content of the peat moss. The lower roller can include perforations allowing moisture to drain away from the peat moss. Speeds of rotation of the rollers and/or a distance between the rollers can be adjustable. A bottom portion underneath the middle portion can include an outlet for discharging the peat moss.

### INTRODUCTION

The following is intended to introduce the reader to the detailed description that follows and not to define or limit the claimed subject matter.

In an aspect of the present disclosure, an apparatus for drying bulk material can include: a housing defining a chamber, an inlet for receiving the bulk material into the chamber, and an outlet for discharging the bulk material from the chamber; at least one conveyor mechanism disposed within the housing and arranged to convey the bulk material from the inlet to the outlet; and a ventilation system coupled to the chamber and configured to remove water vapor from the chamber.

In an aspect of the present disclosure, a method of drying bulk material can include: receiving the bulk material into a chamber; conveying the bulk material within the chamber; removing water vapor from the chamber; and discharging the bulk material from the chamber.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of apparatuses and methods of the present disclosure and are not intended to limit the scope of what is taught in any way.

FIG. 1 shows an example of a system for processing bulk material, which includes a drying apparatus.

FIG. 2 shows a partial cross-section view of the drying apparatus.

FIG. 3 shows a perspective view of the drying apparatus connected to a ventilation system.

FIG. 4 shows a cross-section view of the drying apparatus and the ventilation system, taken along a lateral direction.

FIG. 5 shows a top view of the drying apparatus and the ventilation system.

FIG. 6 shows a cross-section view of the drying apparatus, taken along a longitudinal direction.

FIG. 7 shows a perspective view of a conveyor belt.

FIG. 8 shows a top view of a portion of the conveyor belt.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

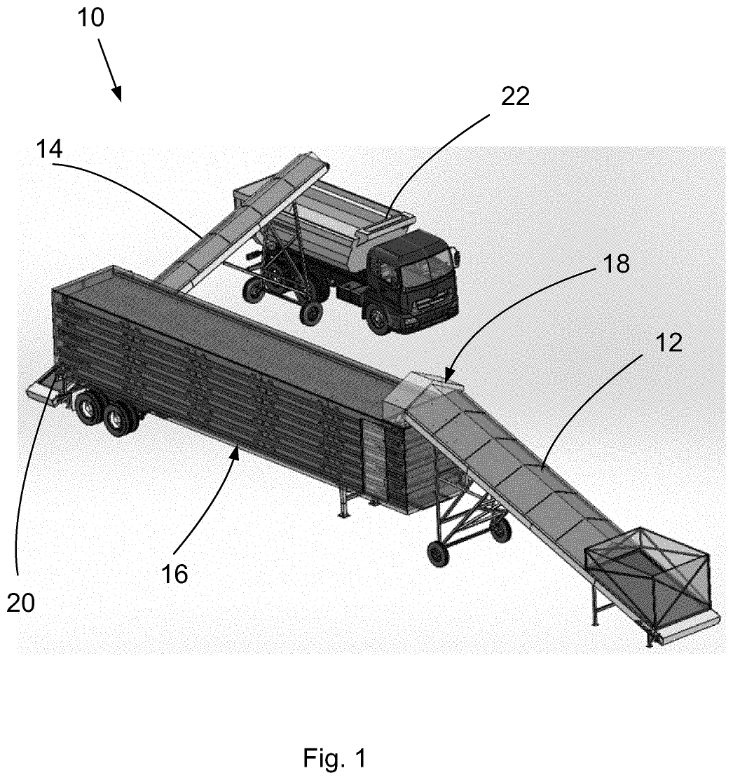

Referring to FIG. 1, an example of a system for processing bulk material is shown generally at reference numeral 10. The system 10 can be used to facilitate the processing of peat moss. In other examples, the system 10 can be used to process other bulk materials, such as soil, manure, wood pulp, vegetables, or other products. Various implementations are possible.

In the example illustrated, the system 10 includes feed unit 12 and outfeed unit 14, and a drying apparatus 16 is arranged between the units 12, 14. The feed unit 12 can supply wet bulk material to the apparatus 16. In the example illustrated, the apparatus 16 includes an inlet 18 for receiving the wet bulk material. The apparatus 16 can dry the bulk material supplied therein. The outfeed unit 14 can receive the dewatered bulk material from the apparatus 16. In the example illustrated, the apparatus 16 includes an outlet 20 for discharging the bulk material from the apparatus 16. The outfeed unit 14 can carry the dewatered bulk material discharged from the outlet 20 of the apparatus 16 to a truck 22, which can transport the dry bulk material to a plant for further processing, such as packaging.

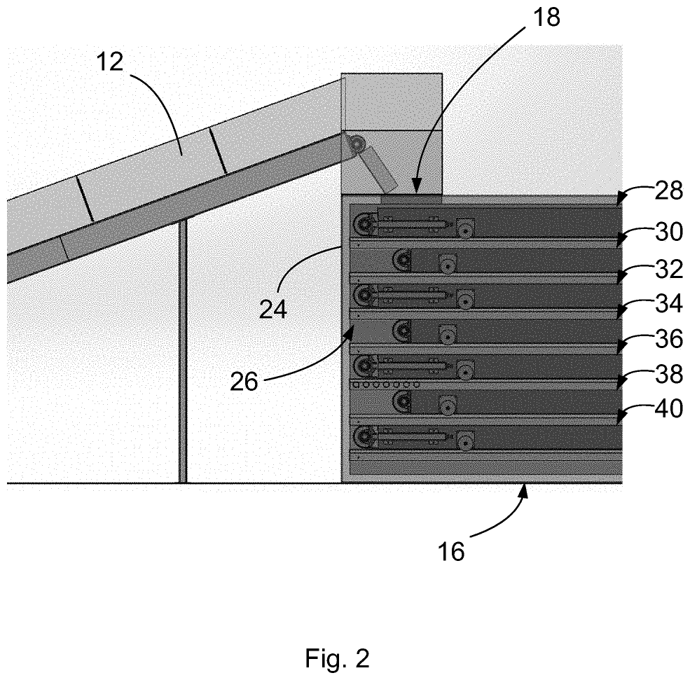

Referring to FIG. 2, the apparatus 16 is shown to include an outer housing 24, and the housing 24 defines a chamber 26. In the example illustrated, the chamber 26 is subdivided into a plurality of subchambers 28, 30, 32, 34, 36, 38, 40, each of which extends laterally and longitudinally within the chamber 26. The subchambers 28, 30, 32, 34, 36, 38, 40 can be separated from one another by horizontal partitions. Seven of the subchambers are shown, but, in other examples, the number of subchambers can vary.

In the example illustrated, a conveyor mechanism is disposed within each of the subchambers 28, 30, 32, 34, 36, 38, 40. The conveyor mechanisms are configured to convey the bulk material within the apparatus 16 from the inlet 18 to the outlet 20 (FIG. 1).

In the example illustrated, the inlet 18 is positioned at an upper section of the housing 24, and the outlet 20 is positioned at a lower section of the housing 24 below the inlet 18. In the example illustrated, the housing 24 includes a first end and a second end spaced longitudinally from the first end, with the inlet 18 adjacent to the first end and the outlet 20 adjacent to the second end.

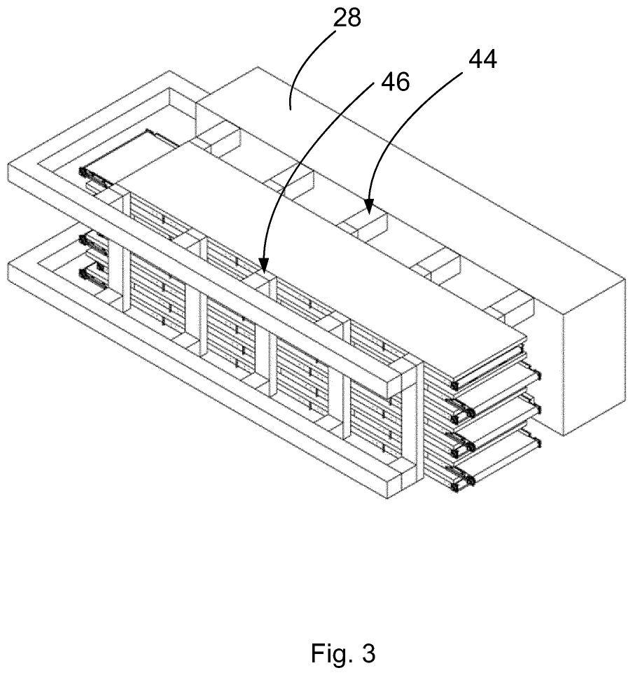

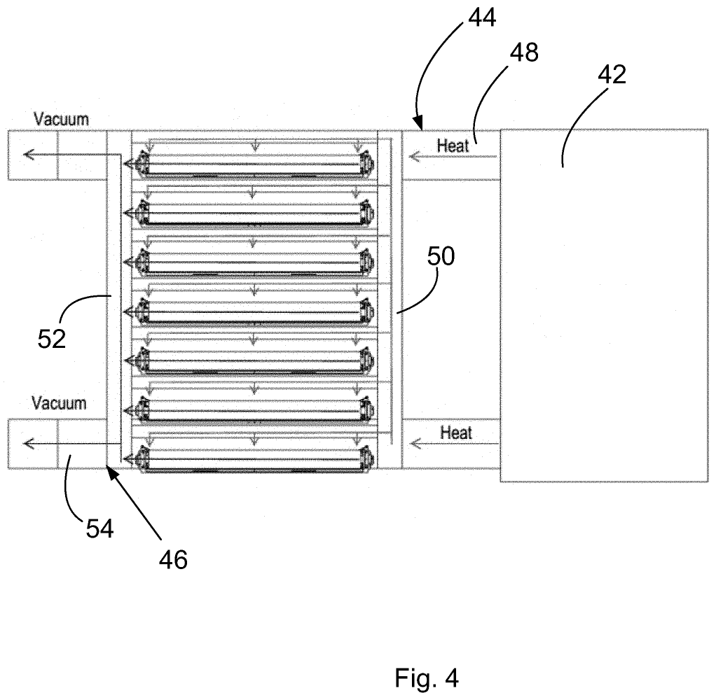

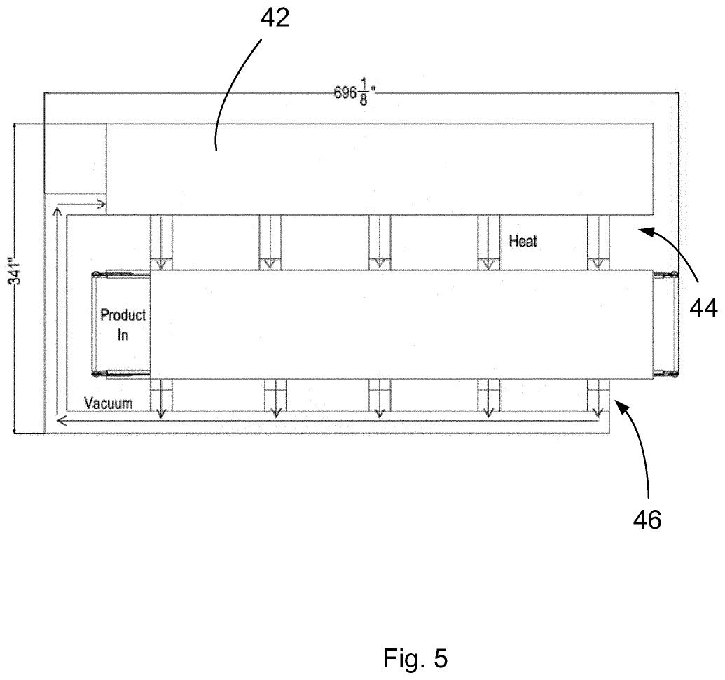

Referring to FIGS. 3, 4 and 5, a ventilation system 42 is shown coupled to each of the subchambers by a supply manifold 44 and a return manifold 46. In the example illustrated, the supply manifold 44 includes horizontal ducts 48 that connect the ventilation system 42 to vertical ducts 50, which span the subchambers. In the example illustrated, the return manifold 46 includes vertical ducts 52 that span the subchambers, and horizontal ducts 54 that connect the vertical ducts 52 to the ventilation system 42. In the example illustrated, the subchambers extend laterally between the manifolds 44, 46, and longitudinally between the ducts 50 on the supply side and between the ducts 52 on the return side.

The ventilation system 42 can be responsible for removing water vapor from the subchambers via the return manifold 46. In some examples, the ventilation system 42 can be configured to maintain the subchambers at a negative pressure relative to an ambient pressure. In some examples, the ventilation system 42 can include a vacuum pump (not shown). Thus, in some examples, the ventilation system 42 can suck air through the system, rather than blowing air through the system.

In some examples, the ventilation system 42 can be configured to supply heated air to the subchambers via the supply manifold 44, to increase the rate of drying of the bulk material. In some examples, the ventilation system 42 can include a heater (not shown), along with a heat exchanger that can be used to recover heat from the air returned via the return manifold 46.

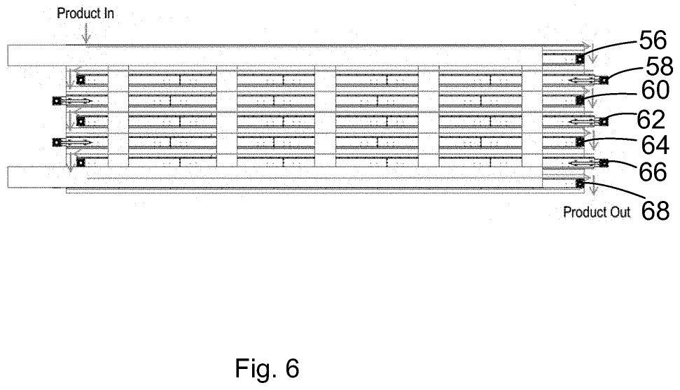

FIG. 6 illustrates the progression of bulk material through the apparatus 16 by conveyor mechanisms 56, 58, 60, 62, 64, 66, 68 (received within the subchambers 28, 30, 32, 34, 36, 38, 40, respectively), which can be said to follow a zigzagging path. Again, while seven of the conveyor mechanisms and subchambers are shown in this example, in other examples, the number can vary.

In the example illustrated, the conveyor mechanisms 56, 58, 60, 62, 64, 66, 68 are arranged to operate in parallel. The conveyor mechanisms 56, 60, 64, 68 are arranged to move the bulk material generally in a first longitudinal direction, i.e. from the inlet 18 towards the outlet 20 (FIG. 1). The conveyor mechanisms 58, 62, 66 are reversed longitudinally so that they move the bulk material generally in a second longitudinal direction (i.e. from the outlet 20 towards the inlet 18 (FIG. 1). The conveyor mechanism 56 receives the bulk material at the inlet 18. When the bulk material reaches the longitudinal extent of each of the conveyor mechanisms 56, 58, 60, 62, 64, 66, it falls below to the adjacent conveyor mechanism by force of gravity. A chute (not shown) can be included at the transition zones to ensure that the bulk material is not dropped too far and damaged. The conveyor mechanism 68 conveys the bulk material to the outlet 20 to be discharged from the apparatus 16.

In the example illustrated, it should be appreciated that the bulk material is travelling generally longitudinally within the apparatus 16, whereas the flow of air is generally lateral in direction.

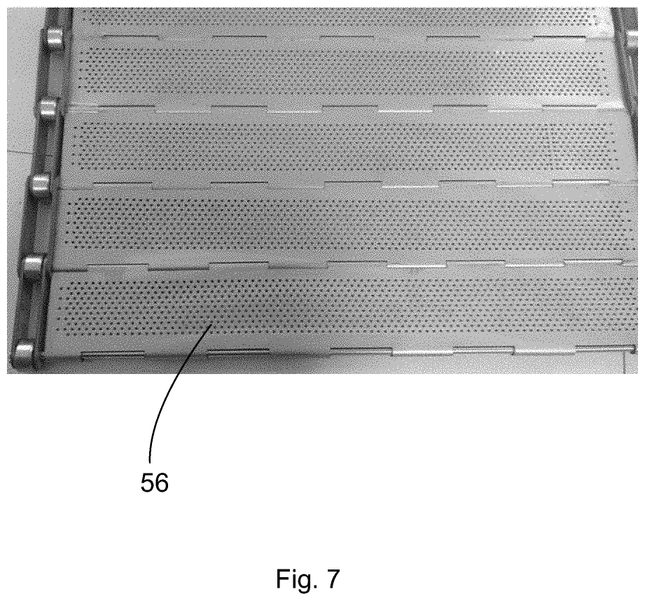

FIG. 7 shows the conveyor mechanism 56, which can be identical to each of the conveyor mechanisms 58, 60, 62, 64, 66, 68.

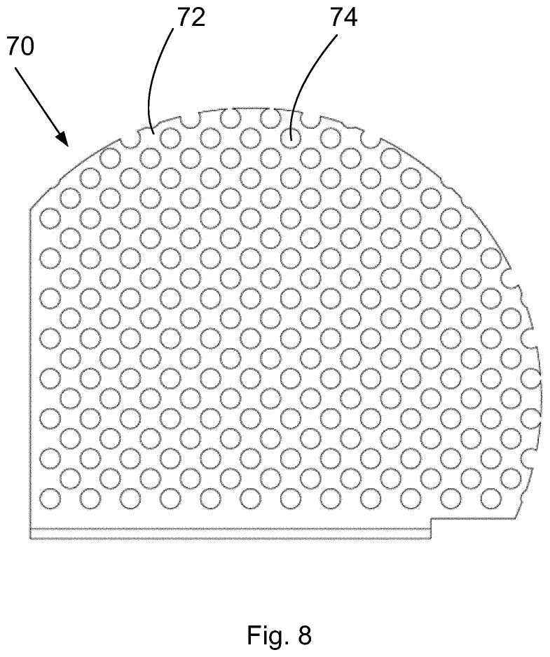

Referring to FIG. 8, a conveyor belt 70 includes a carrying surface 72, and a plurality of perforations 74 to facilitate removal of water vapor from bulk material conveyed on the carrying surface 72 by improving airflow around and through the bulk material.

In some implementations, the drying apparatus 16 can be used to dry peat moss. For example, and not intended to be limiting, density of peat moss supplied to the drying apparatus 16 at the inlet 18 can be about 14 lbs/ft³, and density of peat moss discharged from the drying apparatus 16 at the outlet 20 can be about 7 lbs/ft³.

In the example illustrated, the apparatus 16 is a mobile implementation. Therefore, the apparatus 16 can be moved, e.g. with a tractor-trailer, to a suitable location in the field, as desired. For example, and not intended to be limiting, the mobile version of the drying apparatus can have the following attributes:
53′ long×10′ wide enclosed trailer;
50′ long×8′ wide conveyor;
5 conveyors tall;
Approximate belt speed: 100 ft/min;
Approximate throughput: 66 ft³/min; and
Air flow: approximately 30,000 CFM.

In other examples, the drying apparatus can be implemented at a permanent location, such as in a plant. For example, and not intended to be limiting, the fixed version of the drying apparatus can have the following attributes:
50′ long×8′ wide conveyor;
7 conveyors tall;
Approximate belt speed: 140 ft/min;
Approximate throughput: 93 ft³/min; and
Air flow: approximately 30,000 CFM.

While the above description provides examples of one or more apparatuses or methods, it will be appreciated that other apparatuses or methods may be within the scope of the accompanying claims.

We claim:

1. An apparatus for drying bulk material, comprising:
a housing defining a chamber, an inlet for receiving the bulk material into the chamber, and an outlet for discharging the bulk material from the chamber;
at least one conveyor mechanism disposed within the housing and arranged to convey the bulk material from the inlet to the outlet; and
a ventilation system coupled to the chamber and configured to remove water vapor from the chamber.

2. The apparatus of claim 1, wherein the inlet is positioned at an upper section of the housing, and the outlet is positioned at a lower section of the housing below the inlet.

3. The apparatus of claim 2, wherein the housing comprises a first end and a second end spaced longitudinally from the first end, the inlet is adjacent to the first end and the outlet is adjacent to the second end.

4. The apparatus of claim 1, wherein the at least one conveyor mechanism comprises a plurality of conveyor belts.

5. The apparatus of claim 4, wherein the plurality of conveyor belts are arranged to operate in parallel within the chamber.

6. The apparatus of claim 5, wherein the plurality of conveyor belts comprises at least one first conveyor belt arranged to move the bulk material generally in a first longitudinal direction from the inlet towards the outlet.

7. The apparatus of claim 6, wherein the plurality of conveyor belts comprises at least one second conveyor belt arranged to move the bulk material generally in a second longitudinal direction from the outlet towards the inlet.

8. The apparatus of claim 7, wherein the at least one second conveyor belt is arranged below the least one first conveyor belt and is configured to receive the bulk material by force of gravity.

9. The apparatus of claim 4, wherein each of the plurality of conveyor belts comprises a perforated carrying surface to permit removal of water vapor from the bulk material.

10. The apparatus of claim 1, wherein the ventilation system is configured to maintain the chamber at a negative pressure relative to an ambient pressure.

11. The apparatus of claim 10, wherein the ventilation system comprises a vacuum pump.

12. The apparatus of claim 1, wherein the ventilation system is configured to supply heated air to the chamber.

13. The apparatus of claim 12, wherein the ventilation system comprises a heater.

14. The apparatus of claim 12, comprising a supply manifold for delivering the heated air in parallel to a plurality of subchambers that extend laterally within the chamber.

15. The apparatus of claim 14, comprising a return manifold for removing the water vapor in parallel from the plurality of subchambers.

16. The apparatus of claim 15, wherein the subchambers are fluidly connected to and extend laterally between the supply and return manifolds.

17. An apparatus for drying bulk material, comprising:
a housing defining a chamber, an inlet positioned at an upper section of the housing for receiving the bulk material into the chamber, and an outlet positioned at a lower section of the housing below the inlet for discharging the bulk material from the chamber, the housing comprising a first end and a second end spaced longitudinally from the first end, the inlet is adjacent to the first end and the outlet is adjacent to the second end;
a plurality of conveyor belts disposed within the housing and arranged to convey the bulk material from the inlet to the outlet, the plurality of conveyor belts comprising at least one first conveyor belt arranged to move the bulk material generally in a first longitudinal direction from the inlet towards the outlet, and at least one second conveyor belt arranged to move the bulk material generally in a second longitudinal direction from the outlet towards the inlet, the at least one second conveyor belt is arranged below the least one first conveyor belt and is configured to receive the bulk material by force of gravity; and
a ventilation system coupled to the chamber and configured to remove water vapor from the chamber, the ventilation system comprising a supply manifold for delivering heated air in parallel to a plurality of subchambers that extend laterally within the chamber, and a return manifold for removing the water vapor in parallel from the plurality of subchambers, the subchambers being fluidly connected to and extend laterally between the supply and return manifolds.

18. A method of drying bulk material, comprising:
receiving the bulk material into a chamber;
conveying the bulk material within the chamber;
removing water vapor from the chamber; and
discharging the bulk material from the chamber,
wherein the bulk material consists of peat moss.

19. The method of claim 18, wherein the step of conveying comprises:
conveying the bulk material inside the chamber from an inlet to an outlet; and
operating a plurality of conveyor belts arranged in parallel within the chamber.

20. The method of claim 18, wherein the step of removing comprises:
maintaining the chamber at a negative pressure relative to an ambient pressure; and
supplying heated air to the chamber.
